(19) United States
(12) Patent Application Publication
(10) Pub. No.: US 2004/0250283 A1
(43) Pub. Date: Dec. 9, 2004

(54) Liveness monitoring in a publish/subscribe messaging system

(75) Inventors: John J. Duigenan, Bournemouth (GB); Stephen J Todd, Winchester (GB); Graham D. Wallis, West Wellow (GB)

Correspondence Address: IBM Corporation, IP Law Department, 11400 Burnet Road, Austin, TX, 78758, US

(73) Assignee: International Business Machines Corporation, Armonk, NY

(21) Appl. No.: 10/714,049

(22) Filed: Nov. 13, 2003

(30) Foreign Application Priority Data
Jun. 5, 2003 (GB) 0312894.9

(51) Int. Cl. H04N 7/173; H04H 9/00; H04N 7/16; G06F 17/60; H04N 5/445

(52) U.S. Cl. 725/60; 705/37; 725/24; 725/13

(57) ABSTRACT

The invention relates to a subscriber for indicating liveness to a broker in a multicast publish/subscribe messaging system comprising the broker and a plurality of subscribers. The subscriber, having seen an indication of liveness, sets a timer. If the subscriber sees an indication of liveness prior to the expiry of the timer, then the subscriber cancels the timer. However if an indication of liveness is not seen by the subscriber prior to the expiry of its timer, then the subscriber sends its own indication of liveness to the broker.

This patent application is related to a U.S. patent application entitled “Live Monitoring in a Publish/Subscribe Messaging System”, Ser. No. ______ filed on ______, attorney docket no GB920020070US1, which is incorporated herein by reference.

### FIELD OF THE INVENTION

This invention relates to brokered multicast publish/subscribe messaging systems.

### BACKGROUND OF THE INVENTION

Publish and Subscribe (pub/sub) is an effective way of disseminating information to multiple users. Pub/Sub applications can help to enormously simplify the task of getting business messages and transactions to a wide, dynamic and potentially large audience in a timely manner.

In a pub/sub messaging system, subscribers register their interest in one or more topics. The broker performs a match of publications to interested subscribers and sends a copy of each publication to the appropriate subscribers. The stream of publication messages is divided into a sequence of packets of sizes that are optimal for the transmission medium being used.

To maximise the efficiency of the network utilisation in such a system, it is preferable to multicast the packets that contain the messages which are to be sent to a number of subscribers. Where there are a large number of subscribers for a given topic, the network efficiency gain provided by multicast is greater.

The broker performs the role of multicast transmitter and the subscribers each perform the role of multicast receiver.

To improve network utilisation and security, it is desirable to avoid sending multicast packets from the broker when there are no active subscribers. The broker therefore needs to know that there is at least one active subscriber.

In a reliable multicast pub/sub system, subscribers request retransmission of any packet that is not delivered. Subscribers request retransmission by detecting gaps in the delivery sequence. When a subscriber detects a missing packet it requests retransmission by sending a “negative acknowledgement” or NACK. To avoid the generation of a storm of NACKs when a packet goes missing, the subscribers can use a NACK suppression mechanism, which operates by each subscriber setting a random backoff timer and sending a multicast NACK packet on expiry of the timer. If a subscriber sees another subscriber's NACK packet before its own timer expires, it cancels the timer. (Further information can be found in the background section of U.S. Pat. No. 6,269,080.)

However, this approach has the disadvantage(s) that the only feedback that the broker has is the receipt of NACK packets when one or more subscribers fail to receive a packet; and the notification during orderly subscriber termination that a subscriber no longer wishes to receive publications matching a particular set of topics.

The broker has no guarantee that either of these forms of feedback will be received; no packets may be being dropped; the multicast system may not use NACKs; and subscribers could fail or disconnect unintentionally.

Accordingly, the broker has no knowledge of the current status of the subscribers and is therefore obliged to keep multicasting publications even when no subscribers are actually running, thus reducing the efficiency of such a system.

IEEE Paper “Multicast Delivery Based on Unicast and Subnet Multicast Protocol by Park et al (Vol 5, No 4, April 2001) discloses a system whereby clients periodically inform feeders of their continued existence. This technique does not however scale.

A need therefore exists for efficient liveness monitoring in a multicast system wherein the abovementioned disadvantage(s) may be alleviated.

### SUMMARY

In accordance with a first aspect, the invention provides a subscriber for indicating liveness to a broker in a multicast publish/subscribe messaging system comprising the broker and a plurality of subscribers, the subscriber comprising: means, responsive to seeing an indication of liveness, for setting a timer; means for cancelling the timer if the subscriber sees an indication of liveness prior to the expiry of the timer; and means for sending, on expiry of the timer, an indication of liveness to the broker.

In this way, it is possible for the broker to determine that there is at least one subscriber active (even when no data is being sent, or when the data is lossless).

Note an indication of liveness may be, for example, a NACK or an explicit indication (see later).

In accordance with a preferred embodiment, a subscriber first multicasts a claim that it proposes to indicate its presence to the broker and then the subscriber actually sends the indication.

In an alternative embodiment, the indication of liveness and the claim are one in the same. In this embodiment, the broker listens in on a multicast channel, used by the subscribers, in order to receive any claims from such subscribers. Thus the indication of liveness may be a claim.

The indication of liveness responsive to which the timer is set, may be a claim.

In a preferred embodiment a certain number of subscribers are intended to indicate liveness to the broker. The subscriber is able to receive and store a max value that is representative of the desired number of subscribers. In this way, if a subscriber does not manage to indicate its presence to the broker, another subscriber still should. Thus it is preferably determined whether a desired number of subscribers have indicated liveness. (One such indication may, for example, be a claim. It preferably does not matter whether that claim or (if appropriate) a subsequent presence indication actually reaches the broker) and the timer is cancelled if this is the case. The timer may be cancelled if the subscriber becomes aware that the broker knows of the existence of at least one subscriber.

In one embodiment a subscriber's active connection to the broker is maintained and used for future indications of a subscriber's presence. Such active connections may be initiated by either the broker or by a subscriber. Note, by way of example the connection may be first established at registration or it may be established when the subscriber first desires to send an indication of liveness to the broker.

In one embodiment, the active connection is a TCP connection

Note, the indication may be piggybacked onto another message in order to make more efficient network use.

In one embodiment, the indication of liveness is sent over either a TCP or a UDP connection

Preferably the subscriber is able to receive an indication from the broker that the broker is aware of the presence of at least one subscriber.

In one embodiment the broker is able to determine which subscribers have an active connection to the broker and is able to inform a subscriber that they should set a timer only if that subscriber has an active connection to the broker.

In one embodiment, the broker is able to determine which subscribers have an active connection to the broker and to inform the active subscribers that their timer should be less than a predetermined amount. The predetermined amount is preferably calculated such that the timers set for actively connected subscribers are shorter than for those for subscribers that aren't connected.

In one embodiment, the broker is able to designate as a primary subscriber the first subscriber to register interest in a topic, and to maintain an active connection to the primary subscriber. Preferably, in the event of failure of the primary subscriber, the broker is able to designate as a new primary subscriber the subscriber whose indication of liveness is next received.

Preferably the broker is able to inform at least the primary subscriber that it is responsible for periodically indicating liveness.

According to one aspect, the invention provides a method for indicating liveness to a broker in a multicast publish/subscribe messaging system comprising the broker and a plurality of subscribers, the method comprising: responsive to seeing an indication of liveness at a subscriber, setting a timer; cancelling the timer if the subscriber sees an indication of liveness prior to the expiry of the timer; and sending, on expiry of the timer, an indication of liveness to the broker.

It will be appreciated that the invention may be implemented in computer software.

### BRIEF DESCRIPTION OF THE DRAWING(s)

Embodiments of the present invention will now be described, by way of example only, and with reference to the following drawings:

FIG. 1 shows a block schematic diagram of a publish/subscribe messaging system in which embodiments of the present invention may be used;

FIG. 2 shows a schematic diagram depicting message flows between components of the system of FIG. 1;

FIG. 3 shows a flow diagram depicting method steps of a first technique for liveness monitoring in accordance with an embodiment of the present invention; and

FIG. 4 shows a flow diagram depicting method steps of a second technique for liveness monitoring in accordance with an embodiment of the present invention.

### DESCRIPTION OF PREFERRED EMBODIMENTS

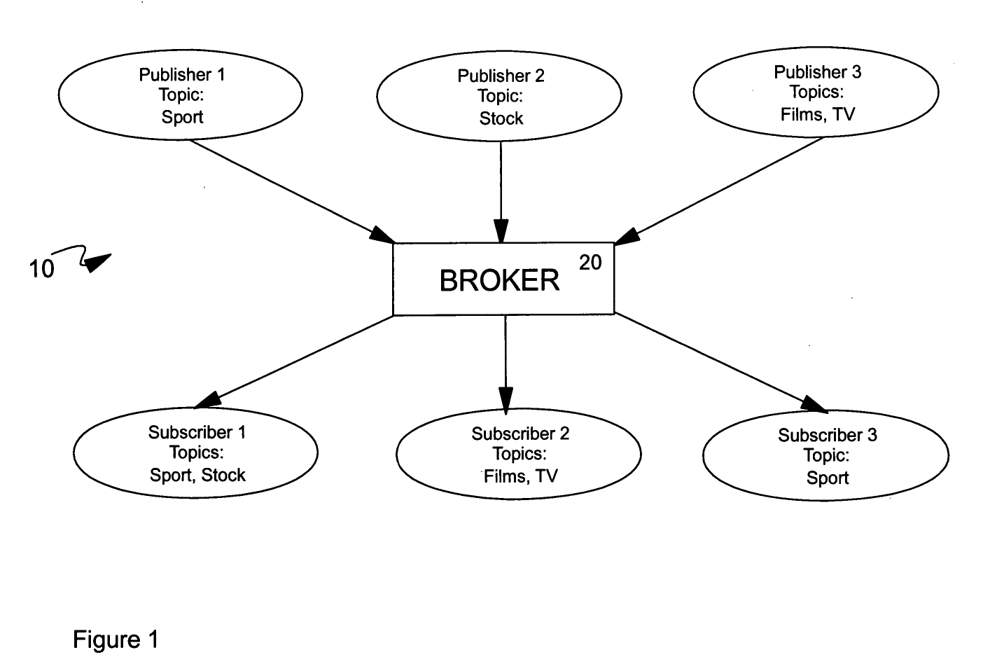

FIG. 1 shows a brokered pub/sub multicast messaging system 10 in which a broker 20 brokers sending of multicast messages from Publisher 1 (publishing information on, for example, the topic of Sport), Publisher 2 (publishing information on, for example, the topic of Stock) and Publisher 3 (publishing information on, for example, the topics of Films & Television) to Subscriber 1 (subscribing to information on, for example, the topics of Sport and Stock), Subscriber 2 (subscribing to information on, for example, the topic of Films & Television) and Subscriber 3 (subscribing to information on, for example, the topic of Sport).

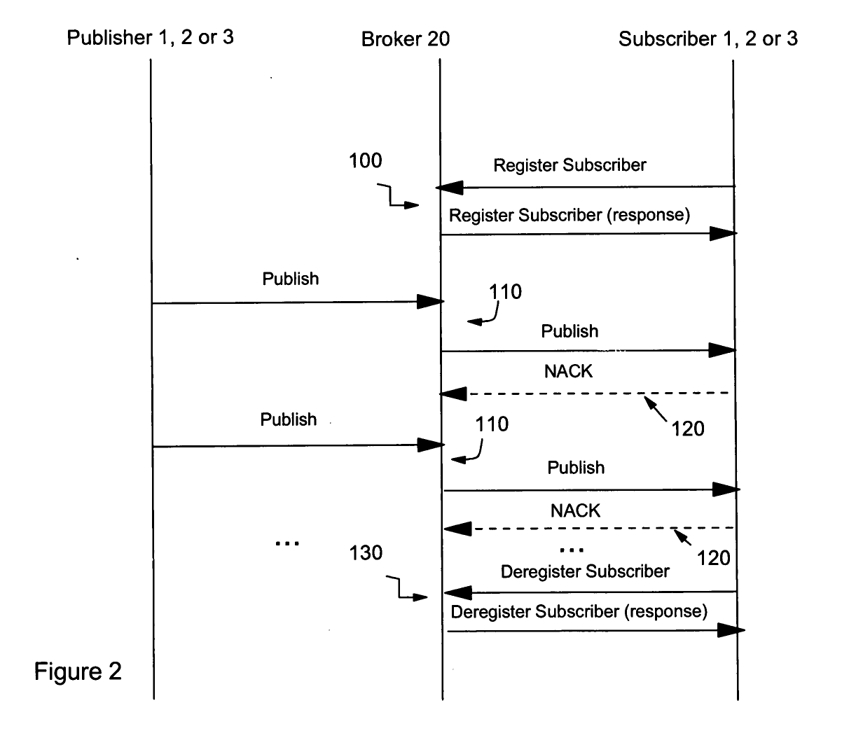

As shown in FIG. 2 at 100, Subscriber 1, Subscriber 2 and Subscriber 3 each send a message to broker 20 to register the respective subscriber therewith. In response thereto, the relevant subscriber receives a message from broker 20 confirming registration. Thereafter, as shown at 110, each publisher publishes its information to broker 20, and the broker publishes the information to subscriber(s) that have registered with the broker to receive such information.

As referred to above, if a subscriber operating in a reliable multicast system and detects a missing packet it requests retransmission by sending a “negative acknowledgement” or NACK 120.

Finally, as shown at 130, Subscriber 1, Subscriber 2 and Subscriber 3 may each send a message to broker 20 to deregister the respective subscriber from the broker, and in response thereto the relevant subscriber receives a message from broker 20 confirming deregistration.

In system 10 it is desired, to improve network utilisation and security, by avoiding sending multicast packets from the broker when there are no active subscribers. The broker therefore needs to be aware of the presence of at least one active subscriber. It is not sufficient to rely on the subscribers deregistering when they are deactivated, because a subscriber may be accidentally disconnected or fail and not get a chance to deregister.

Furthermore, it is important for each subscriber to know if the broker fails and is restarted, so that subscriptions can be re-registered, fresh security keys exchanged and packet sequence numbers can be reset.

The following conditions together preferably indicate the liveness of the system:

Condition 1): The broker knows that there is at least one active subscriber;

Condition 2): Each subscriber knows that the broker is still active; and

Condition 3): The broker knows that at least one active subscriber can receive multicast packets.

In order to enable the broker to ascertain the presence of at least one active subscriber (i.e. to satisfy condition 1), the broker needs to periodically receive an indication of liveness from at least one subscriber.

In a reliable multicast system, when there is data to be sent and there are packet losses, some subscribers will be sending NACK packets. From the receipt of a NACK, the broker can infer the presence of at least one active subscriber.

When there is no data to be sent; any data transmission is lossless; or when unreliable multicast is being used, there will be no NACK packets. In such a situation, it is not possible for the broker to tell whether there is at least one active subscriber in receipt of its publications.

The following techniques preferably address such a situation:

Technique #1

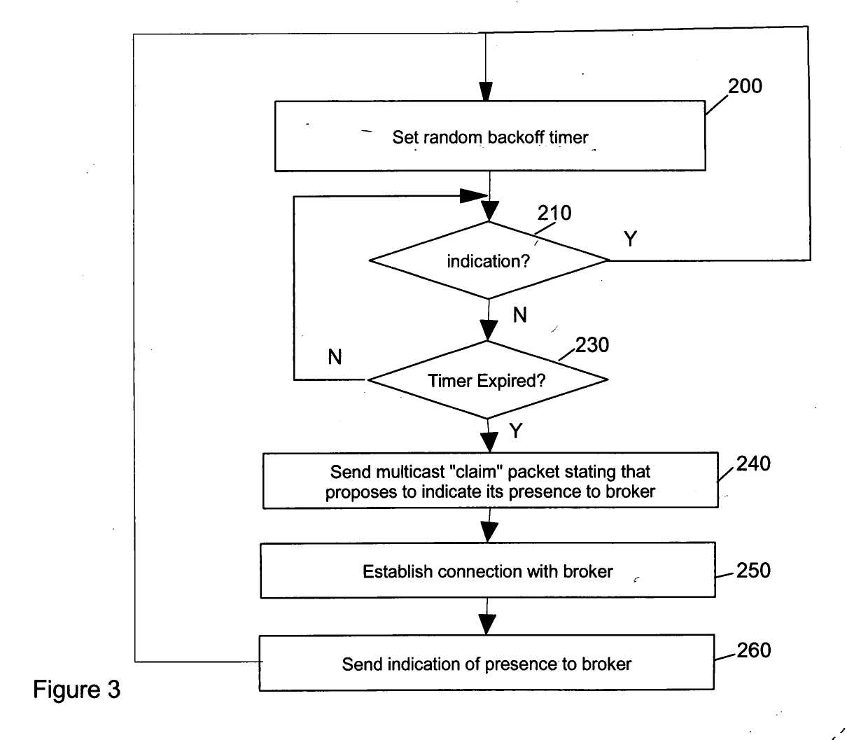

With reference to FIG. 3, (upon for example startup), each subscriber sets a random backoff timer (step 200).

Upon expiry of a subscriber's timer, that subscriber sends a multicast “claim” packet stating that it proposes to indicate its presence (via a presence packet) to the broker (steps 230, 240).

The subscriber then establishes a point-to-point connection with the broker and sends a presence packet to the broker (steps 250, 260). The subscriber then cancels (not shown) and resets its timer (step 200).

Note, each subscriber prior to expiry of its timer continues to check whether another subscriber is responsible for indicating liveness to the broker (step 210). A subscriber may determine that another subscriber is alive (and responsible for indicating this to the broker) via for example a NACK packet, a claim packet or via a confirmation packet sent by the broker to indicate that the broker is aware of the existence of a subscriber. If a subscriber sees an indication of liveness before its own timer expires, then the subscriber cancels (not shown) and resets its own timer (step 200). (The indication of liveness can be discarded since the subscriber relies upon the knowledge that another subscriber has the task of indicating liveness to the broker in hand.)

In this way, the network is not flooded with liveness indications from subscribers.

Note, in a reliable multicast system, the broker will already be listening on the multicast channel for NACKs. Thus the broker may hear any “claim” packets. It is however preferable (even in such a reliable system) for a subscriber to first multicast a “claim” packet and then to unicast a packet to the broker indicating its presence. This is because multicast is typically less reliable than unicast transmission and thus the broker may not ever see a subscriber's claim—the broker should however receive the unicast indication of the subscriber's presence.

Further, in an unreliable multicast system, the broker is unlikely to be listening on the multicast channel. Thus a unicast indication of presence is also appropriate in this situation. (Of course the broker could listen on the multicast channel even in an unreliable multicast system. Where the broker does this it is possible to dispense with “claim” packets altogether—in which case a claim/presence packet is one in the same. This would however not be such a reliable method for the reasoning discussed above.)

Note, by having the broker listen in on the multicast channel condition 3 is tested—i.e. whether there is at least one active subscriber that can receive multicast packets. This is because a subscriber sets their timer in response to seeing an indication of liveness (which will frequently be sent via the multicast channel) and will then claim on expiry of the timer.

Using technique #1, the broker may receive multiple liveness indication packets (see next paragraph), but the number should be minimised by the above algorithm.

Multiple indications of liveness may be received when more than one subscriber has a backoff timer with a value that causes their timers to expire (and fire an event) at approximately the same time. Note, subscribers don't necessarily see the same packet at the same time. So a packet that causes a subscriber to cancel any existing timer and start a new timer may be seen at time T1 at Subscriber1 and at time T2 at Subscriber2. They will each start a timer at the time they see the packet. On expiry of one subscriber's timer that subscriber will decide to send a packet and having made that decision will embark on the processing needed to do so. It is only when that processing is completed and the packet has been sent that it will be received by any other subscribers—hence it's quite possible for a number of subscribers to make the same decision and hence send multiple packets.

As a result of an indication of liveness from a subscriber, the broker may transmit an “indication received” packet on the multicast channel. By transmitting such a packet to all subscribers, condition 2 is also satisfied. In other words, the subscribers can infer that the broker is still active.

Subscribers can also infer that the indication of presence (or a claim packet) reached the broker—i.e. that the “claiming subscriber” did actually manage to inform the broker of its presence.

It will be appreciated from the above, that there is the possibility that a “claiming subscriber” may fail before managing to send an indication to the broker. Alternatively, the indication may simply not reach the broker.

Technique #2

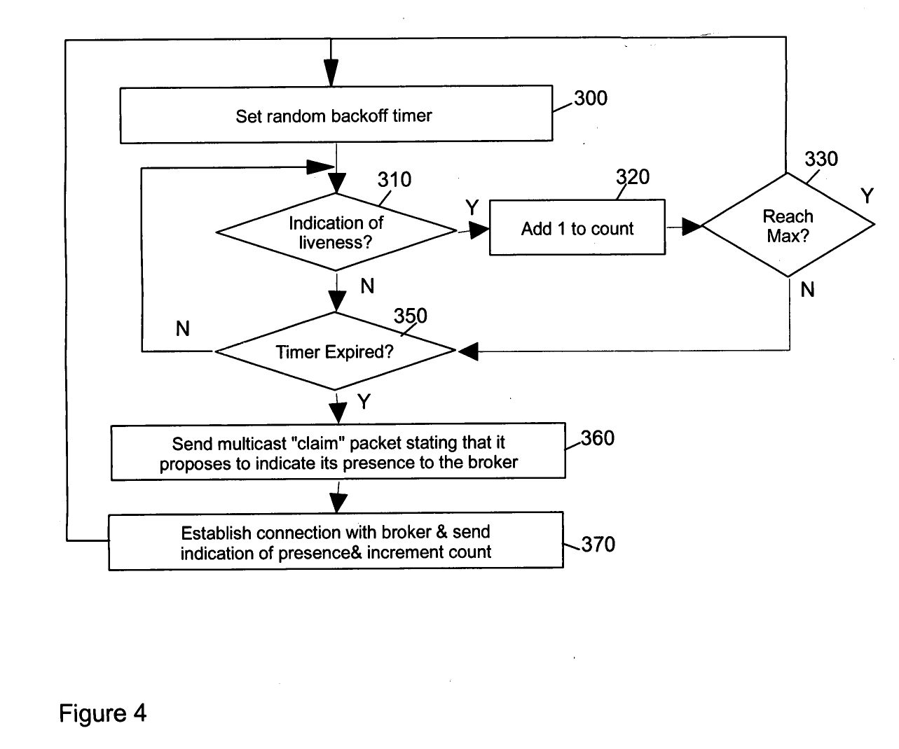

A second technique for liveness monitoring is presented with reference to FIG. 4. This technique is similar to technique #1 but is based on the intent of a number of subscribers to respond. This provides a degree of tolerance to subsequent subscriber failures.

Subscribers are informed (e.g. upon registration) that the broker expects x (stored by each subscriber as a max value) of them to attempt to indicate liveness after a certain time of seeing no other indications.

Each subscriber (upon for example startup) starts a timer (step 300) and initialises a count to zero (not shown). Whilst the timer runs, the subscriber will continually check whether it has seen an indication of liveness from another subscriber (step 310). If such an indication (e.g. a NACK or claim) is seen, then the subscriber will discard the indication, add 1 to the count (step 320) and will then verify whether the max value has been reached (step 330).

If the max value has been reached (prior to the expiry of the subscriber's own timer), then the subscriber's timer is cancelled (not shown) and is set at step 300. The count is also reset to zero (not shown) (i.e. the subscriber will not send an indication of liveness to the broker this time around).

Otherwise, upon expiry of the timer (step 350), the subscriber may check the max value (not shown) and assuming that this value has not been reached “claims” that it proposes to indicate its presence to the broker (step 360). The subscriber subsequently establishes a connection with the broker and then sends an indication of its presence to the broker and increments its count (step 370). The subscriber then cancels the timer (not shown) and sets the timer to run again (step 300).

Upon receipt of such an indication, the broker may send an “indication received” packet on the multicast channel (not shown). Other subscribers may then cancel and reset their timers and reinitialise their count. Thus, despite the intention of x subscribers to indicate liveness to the broker, the broker will in general handle less than x incoming indications of liveness.

In this way, a subscriber with a pending backoff timer cancels it only if it receives at least x multicast indications of liveness from other subscribers before the backoff timer expires, or if it receives an indication from the broker itself. This will mean that at least x subscribers will try to respond to the broker, reducing the risk that the broker will not be informed of subscriber liveness.

If a subscriber who has sent a “claim” packet subsequently fails before managing to send a presence packet, or if a subscriber sends an indication of liveness which doesn't get through to the broker, then the broker should still receive a response from an alternative responding subscriber. This is because any subscriber whose max value has not been reached will, upon expiry of its timer, also indicate liveness to the broker.

Just as with technique #1, the broker may receive multiple indication packets (as discussed earlier), but the number should be minimised by the above algorithm.

It will be appreciated that the broker may escalate from technique #1 to technique #2 (with an indication quota greater than 1) in the event of no responses being received within an acceptable time period. The broker may also revert from technique #2 to technique #1.

An alternative to technique #2 (which assures at least two indications but does not require a predetermined number of subscribers to attempt to indicate liveness) is as follows: subsequent to a first subscriber claiming/sending a NACK, the other subscribers each set a short random backoff timer. The first other subscriber whose timer expires is then also charged with “claiming” and “indicating” to the broker. All subscribers will however cancel their timers if an “indication received” packet is seen in the meantime from the broker.

As discussed above, in order to have reliable communication of the feedback, indications to the broker are preferably unicast over a TCP (Transmission Command Protocol) connection rather than through the multicast fabric. Rather than using TCP, the indications can be sent using UDP (User Datagram Protocol), which is a less reliable point-to-point protocol. The lower reliability may lead to fewer indications reaching the broker; on the other hand, it avoids TCP connection setup cost.

TCP setup incurs a heavy per-connection overhead in terms of the number of packets sent—e.g., 7 packets to set up the connection compared to one “liveness” packet to be sent).

The choice of protocol could therefore be made dependent on the loss rate and number of subscribers and made as a result of dynamic evaluation of these parameters, thereby providing self-optimising characteristics. The broker can escalate from UDP to TCP in the event of no indications being received within an acceptable time period.

It would alternatively be possible in principle to use the multicast protocol to achieve this, but since there is only one intended recipient it is more efficient to use a unicast protocol—hence TCP or UDP.

It will be appreciated, that it is because a unicast protocol is preferably used to respond to the broker, that subscribers first “claim” that they will indicate liveness. Subscribers “claim” on the multicast channel and then unicast the actual indication to the broker.

In an unreliable multicast system (i.e. a system in which the broker is not already listening on the multicast channel), rather than subscribers actually having to send an indication of presence to the broker, the broker may be arranged to be a listener on the multicast channel, so that it hears the ‘claim’ from subscribers, without any other explicit subscriber to broker response being necessary. In other words, the broker may subscribe to receive “claim” packets. In this embodiment condition 3 is tested—i.e. whether there is at least one active subscriber that can receive multicast packets.

(Note, the broker does not hear an claims within a certain period of timer, then the broker may request that subscribers use both claim and presence indications.)

Note, even in embodiments where the broker does not listen in on the multicast channel, there should be clues as to condition 3—i.e. if the multicast channel ceases to work then the subscribers' claim packets will not get through to the other subscribers and there would be a storm of liveness indications. This would be a clue to the broker that the multicast channel is not working.

Technique #3

A third technique provides a performance optimisation in the case where a TCP connection (or setup intensive connection—see earlier) is to be used for the subscriber-to-broker indication of liveness channel. This technique can be used in combination with either of the techniques #1 and #2 described above.

During registration of a subscriber a TCP connection is established between the subscriber and the broker. Once subscription (including key exchange, etc.) is complete the TCP connection could be disconnected. This is beneficial for scalability. However, if at least some of the TCP connections are maintained beyond the end of the subscription protocol, then they can be re-used to indicate subscriber liveness to the broker, avoiding the overhead of re-establishing a TCP connection, which would be considerable. (As previously mentioned TCP setup incurs a heavy per-connection overhead in terms of the number of packets sent.)

Each TCP connection can be associated with an idle timer and can be disconnected on expiry of the idle timer. Whenever a connection is used (for subscription, key exchange or status traffic) the idle timer is reset.

In one embodiment, only those subscribers with active connections to the broker, set random backoff timers. In this way, there will be no need to establish a connection before sending an indication of liveness to the broker. This option should reduce the number of indications sent at the expense of some additional complexity in the subscriber-side code.

In an alternative embodiment, those subscribers with active connections always have shorter backoff timers than those without such pre-established connections.

The advantage of the alternative embodiment is, that if all subscribers with active connections fail to indicate liveness to the broker, one of the other subscribers is still given the opportunity to first establish a connection and to then indicate liveness.

In a further embodiment a subscriber, that sent a presence indication to the broker and consequently has had to establish a point to point connection with the broker, leaves that connection open for future use. From this moment on, this subscriber will know it has an active connection to the broker, and will respond more rapidly, according to the rules described above.

Note, in accordance with a preferred embodiment either one subscriber attempts to indicate liveness (technique #1) or a predetermined number attempt to indicate liveness (technique #2).

Technique #4

A fourth technique, alternative to technique #3 described above, contains a performance modification which is that the broker notes the identity of the first subscriber to register interest in a topic. The broker maintains the TCP connection to this subscriber. The broker then informs the designated subscriber that it is responsible for informing the broker periodically of liveness.

If the designated subscriber fails then the broker will detect this because the TCP connection will be broken. In this case the broker can designate another subscriber or multicast to the other subscribers that they are all responsible for indicating liveness (or the broker can inform only some subscribers). The designated subscriber, some or all subscribers (as appropriate) can then set a random backoff timer and revert to technique #1 or #2.

According to one embodiment, after a predetermined time of seeing no indication of liveness, the broker may actually send out a request for status on the multicast channel. Each subscriber can set a timer in response to seeing such a status request. On expiry of a subscriber's timer, that subscriber can claim and indicate presence to the broker. This is discussed in co-pending GB patent application 0308035.5 (Attorney Docket: GB9-2002-0070) and is applicable to all techniques.

It will be understood that in any of the above techniques it would be possible to use a custom reliable point to point protocol in place of UDP or TCP for the response channel from each subscriber to the broker.

It will be appreciated from the above, that the term “indication of liveness” may be taken to encompass “claim” packets; NACKs; presence packets; “indication received” packets.

Liveness indications may be piggybacked onto other messages. As discussed above, such indications may encompass: presence indications—where there is traffic being sent to the broker for other reasons (e.g. a data flow); claims—where subscribers are multicasting between one another for other reasons; indication received packets—where there is other data to be sent from the broker to the subscriber. Piggybacking increases the efficiency of network utilization.

Note, piggybacking is only easy if there are two packets that have the same “class” (i.e. both unicast or both multicast) and they are destined for the same address then it is possible to piggyback one of them on the other.

Note, a subscriber may keep track of the last confirmation message received from the broker. If a certain period of time has elapsed since the last confirmation, a subscriber may decide to “claim” and indicate its presence to the broker even though its timer has not yet expired.

It will be appreciated that the method described above for liveness monitoring in a publish/subscribe messaging system may be carried out in software running on a processor (not shown), and that the software may be provided as a computer program element carried on any suitable data carrier (also not shown) such as a magnetic or optical computer disc.

In summary, it will be understood that the techniques for efficient liveness monitoring in a multicast system described above provides the advantage of improving the efficiency of network usage by reducing the number of unwanted packets that are sent.

Using such mechanisms, it is possible for the broker to determine whether or not there is an active subscriber in receipt of its messages.

What is claimed is:

1. A subscriber for indicating liveness to a broker in a multicast publish/subscribe messaging system comprising the broker and a plurality of subscribers, the subscriber comprising:
means, responsive to seeing an indication of liveness, for setting a timer;
means for cancelling the timer if the subscriber sees an indication of liveness prior to the expiry of the timer; and
means for sending, on expiry of the timer, an indication of liveness to the broker.

2. The subscriber of claim 1, wherein the means for sending an indication of liveness comprises:
means for multicasting a claim that the subscriber proposes to send an indication of its presence to the broker; and
means for sending a presence indication to the broker.

3. The subscriber of claim 2, wherein the indication of liveness responsive to which the timer is set is a claim.

4. The subscriber of claim 1, wherein the means for cancelling the timer comprises:
means for determining at least one of i) if a desired number of subscribers have indicated liveness and ii) that the broker is aware of the presence of at least one subscriber; and
means, responsive to determining that a desired number of subscribers have indicated liveness and/or that the broker is aware of the presence of at least one subscriber, for cancelling the timer.

5. The subscriber of claim 4 comprising:
means for receiving and storing a max value, the max value being representative of the desired number of subscribers.

6. The subscriber of claim 1, wherein in operation an active connection between the broker and the subscriber is maintained, the subscriber comprising:
means for using the active connection to send an indication of its presence to the broker.

7. The subscriber of claim 6, wherein the active connection is a TCP connection.

8. The subscriber of claim 1, wherein the indication of liveness is piggybacked onto another message.

9. The subscriber of claim 1, wherein the indication of liveness is sent over one of:
a UDP connection; and
a TCP connection.

10. The subscriber of claim 1 comprising:
means for receiving an indication from the broker that the broker is aware of the presence of at least one subscriber.

11. A broker for liveness monitoring in a multicast publish/subscribe messaging system comprising a plurality of subscribers as claimed in claim 1, wherein the broker is operable to maintain at least one active connection between the broker and at least one subscriber, the broker comprising:
means for determining which subscribers have an active connection to the broker; and
means for informing a subscriber that they should set a timer only if that subscriber has an active connection to the broker.

12. A broker for liveness monitoring in a multicast publish/subscribe messaging system comprising a plurality of subscribers as claimed in claim 1, wherein the broker is operable to maintain at least one active connection between the broker and at least one subscriber, the broker comprising:
means for determining which subscribers have an active connection to the broker; and
means for informing such active subscribers that their timer should run for less than a predetermined amount.

13. The broker of claim 11, the broker comprising:
means for designating as a primary subscriber the first subscriber to register interest in a topic; and means for maintaining an active connection to the primary subscriber.

14. The broker of claim 13 comprising:
means for, in the event of failure of the primary subscriber, designating as a new primary subscriber the subscriber whose indication of liveness is next received.

15. The broker of claim 13 comprising:
means for informing at least the primary subscriber that it is responsible for periodically indicating liveness to the broker.

16. A broker for liveness monitoring in a multicast publish/subscribe messaging system comprising a plurality of subscribers as claimed in claim 1, the broker comprising:
means for listening in on a multicast channel, used by the subscribers, in order to receive any indications of liveness from said subscribers.

17. A method for indicating liveness to a broker in a multicast publish/subscribe messaging system comprising the broker and a plurality of subscribers, the method comprising:
responsive to seeing an indication of liveness at a subscriber, setting a timer;
cancelling the timer if the subscriber sees an indication of liveness prior to the expiry of the timer; and
sending, on expiry of the timer, an indication of liveness to the broker.

18. The method of claim 17, wherein the step of sending an indication of liveness comprises:
multicasting a claim that the subscriber proposes to send an indication of its presence to the broker; and
sending a presence indication to the broker.

19. The method of claim 18, wherein the indication of liveness responsive to which the timer is set is a claim.

20. The method of claim 17, wherein the step of cancelling the timer comprises:
determining at least one of i) if a desired number of subscribers have indicated liveness and ii) that the broker is aware of the presence of at least one subscriber; and
responsive to determining that a desired number of subscribers have indicated liveness and/or that the broker is aware of the presence of at least one subscriber, cancelling the timer.

21. The method of claim 20 comprising the steps of:
receiving and storing a max value, the max value being representative of the desired number of subscribers.

22. The method of claim 17, wherein the broker is operable to maintain at least one active connection between itself at least one subscriber, the method comprising:
using one such active connection to send an indication of a subscriber's presence broker.

23. The method of claim 22, wherein the active connection is a TCP connection.

24. The method of claim 17, wherein the indication of liveness is piggybacked onto another message.

25. The method of claim 17, wherein the indication of liveness is sent over one of:
a UDP connection; and
a TCP connection.

26. The method of claim 17 comprising:
receiving an indication from the broker that the broker is aware of the presence of at least one subscriber.

27. A method for liveness monitoring in a multicast publish/subscribe messaging system comprising a plurality of subscribers as claimed in claim 1, wherein the broker is operable to maintain at least one active connection between the broker and at least one subscriber, the method comprising:
determining which subscribers have an active connection to the broker; and
informing a subscriber that they should set a timer only if that subscriber has an active connection to the broker.

28. A method for liveness monitoring in a multicast publish/subscribe messaging system comprising a plurality of subscribers as claimed in claim 1, wherein the broker is operable to maintain at least one active connection between the broker and at least one subscriber, the method comprising:
determining which subscribers have an active connection to the broker; and
informing such active subscribers that their timer should be less than a predetermined amount.

29. The method of claim 27 comprising:
designating as a primary subscriber the first subscriber to register interest in a topic; and
maintaining an active connection to the primary subscriber.

30. The method of claim 29 comprising:
in the event of failure of the primary subscriber, designating as a new primary subscriber the subscriber whose indication of liveness is next received.

31. The method of claim 29 comprising:
informing at least the primary subscriber that it is responsible for periodically indicating liveness to the broker.

32. A method for liveness monitoring in a multicast publish/subscribe messaging system comprising a plurality of subscribers as claimed in claim 1, the method comprising:
listening in on a multicast channel, used by the subscribers, in order to receive any indications of liveness from said subscribers.

33. A computer program for indicating liveness to a broker in a multicast publish/subscribe messaging system comprising the broker and a plurality of subscribers, the computer program comprising program code means adapted to perform the steps of:
responsive to seeing an indication of liveness at a subscriber, setting a timer;
cancelling the timer if the subscriber sees an indication of liveness prior to the expiry of the timer; and
sending, on expiry of the timer, an indication of liveness to the broker.
